(19) United States
(12) Patent Application Publication
(10) Pub. No.: US 2004/0071150 A1
(43) Pub. Date: Apr. 15, 2004

(54) Updating presence information

(76) Inventors: Anu Honkala, Nokia (FI); Jykri Aarnos, Kangasala (FI); Juha Kaitaniemi, Tampere (FI); Juha Kalliokulju, Vesilahti (FI); Eva-Maria Leppanen, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/612,342

(22) Filed: Jul. 3, 2003

(30) Foreign Application Priority Data
Jul. 5, 2002 (GB) 0215620.6

(51) Int. Cl. H04L 12/28; H04L 12/56; H04J 3/16; H04J 3/22

(52) U.S. Cl. 370/401; 370/465

(57) ABSTRACT

In a communication network including at least one user associated with a plurality of terminals, a method of administering information associated with at least one user and/or the plurality of terminals, the method comprising: transmitting to a server a first message from a first terminal of the at least one user, the first message comprising message information and an identifier of the first terminal; and transmitting a second message including at least part of said message information from the server to at least one of only the other terminals of the user.

### BACKGROUND OF THE INVENTION

1. Field of the Invention

The present invention relates to the administration of presence information such as user status information, authorisation information, and other network information in communications networks, and particularly but not exclusively to a presence service in such networks. The invention relates to users with more than one terminal particularly but not exclusively connected to a Third Generation (3G) mobile network.

2. Description of the Related Art

In Third Generation IMS (IP Multimedia Core Network Subsystem) communications systems, a “presence service” will be available to users. The presence service utilises a server to accept information, store it, and distribute it. The information stored may for example relate to the users' willingness to communicate or their capability for communication, or it may be general information relating to the users, or graphics data. The service offers users the opportunity to receive status information relating to one or more other user(s).

The server receives information from “presentities”, i.e. users who provide information to be stored and distributed. Other users may then receive this presence information from the server. For example, a “watcher”—a user who receives presence information of a presentity—might subscribe to the presence service in order to be notified by the server when there is a change in the presence information of a particular presentity, or a watcher might simply request the current value of a particular presentity's presence information. Alternatively, a watcher could subscribe to the service so that he would be notified of a change in the presence information of any of a set of presentities.

The following are examples of details that could be stored and distributed by the presence service: physical location (e.g. “at the office” or “at home”); call state (e.g. “ready to accept communications” or “on another call”—possibly even including the identity of the other party); willingness to accept communication (e.g. “available” or “in a meeting”—this could depend on who is asking); and preferred medium (e.g. video, voice, instant messaging (IM), email). The extent of the presentity's information to be provided to the watcher may depend on the relationship of the watcher to the presentity. For example a friend may be able to receive detailed information, whereas a stranger may be allowed only to receive limited information.

Many enhanced services will be available through the use of presence information, such as reachability services, location-based call screening, live connections and instant conferencing. If presence becomes a ubiquitous service subscribers would tend to check the communications state before establishing communications with anyone whether they normally subscribed to them or not. Knowing in advance what a person's communications state was and the methods of communication for which he or she was available could eliminate the irritation of constant engaged tones and “phone tag”.

As can be imagined, there are endless possibilities for services that could be provided through presence.

An ISIM (IMS subscriber identity module) identifies a subscription to an IMS network. It does not identify a terminal, and therefore it cannot identify a specific terminal that initiates a presence information update.

At present, therefore, there is no provision for supporting the use of multiple terminals associated with a single user in IP-based 3G systems. A user might wish to access presence information via, for example, a mobile phone, a PC or a PDA (personal digital assistant). It is desirable that this should be possible, and, in addition, that the terminal used to send update information to the presence service should be synchronised with the other of the user's terminals.

It is an object of the present invention to overcome one or all of the above-stated problems by providing an improved technique for administering presence information.

### SUMMARY OF THE INVENTION

According to the present invention there is provided, in a communication network including at least one user associated with a plurality of terminals, a method of administering presence information associated with at least one of the at least one user and the plurality of terminals, the method comprising: transmitting to a server a first message from a first one of said terminals, the first message comprising presence information and an identifier of the first terminal.

Preferably the method further comprises the step of transmitting a second message including at least part of said presence information from the server

Preferably the second message is transmitted to at least one of the other of said terminals. Preferably the second message is not transmitted to the first terminal.

Advantageously, this enables a user to update his/her information from any one of the terminals he/she is associated with, and the other terminals of the user are kept informed of the update so that the information in all terminals remains synchronised.

A second message sent to the first terminal would be superfluous, and would require extra air space. It is therefore advantageous that the server preferably transmits the second message only to some or all of the other terminals of the user.

It is a further advantage of the present invention that standard SUBSCRIBE and NOTIFY messages can be used. These messages are well-known in IETF and 3G IMS system models. The SUBSCRIBE and NOTIFY messages are sent by users and servers respectively within a presence service. Other services or concepts can also use the same standard mechanism.

In accordance with a second aspect of the present invention there is provided a communication network including at least one user associated with a plurality of terminals, a server for administering presence information associated with at least one of the at least one user and the plurality of terminals, the server comprising: input means for receiving a first message from a first one of said terminals, the first message comprising presence information and an identifier of the first terminal.

The server may further comprise output means for transmitting a second message including at least part of said presence information. The second message is preferably transmitted to at least one of the other of said terminals of the user.

In a third aspect the present invention provides a communication system including at least one user associated with a plurality of terminals, and a server for administering presence information associated with at least one of the at least one user and the plurality of terminals, wherein the server comprises input means for receiving a first message from a first one of said terminals, the first message comprising presence information and an identifier of the first terminal; and output means for transmitting a second message including at least part of said presence information. The second message is preferably transmitted to at least one of the other of said terminals.

### BRIEF DESCRIPTION OF DRAWINGS

The invention will now be described with reference to the accompanying drawings, in which:

FIG. 1 shows an illustrative example in which several terminals associated with a presence subscriber in a 3G IMS network and several terminals associated with other subscribers in the network;

FIG. 2 is a signalling chart showing the sequence of signals transmitted according to a preferred embodiment of the present invention;

FIG. 3 is a flow chart showing the steps of the preferred embodiment of the present invention.

### DETAILED DESCRIPTION OF THE PREFERRED EMBODIMENTS

The invention is described hereinbelow with reference to a non-limiting embodiment. In particular, the invention is described in relation to the provision of a presence service in a 3G IMS mobile communications network. However, the invention is not limited to such a service or such a network.

In the figures, like reference numerals have been used to indicate like parts.

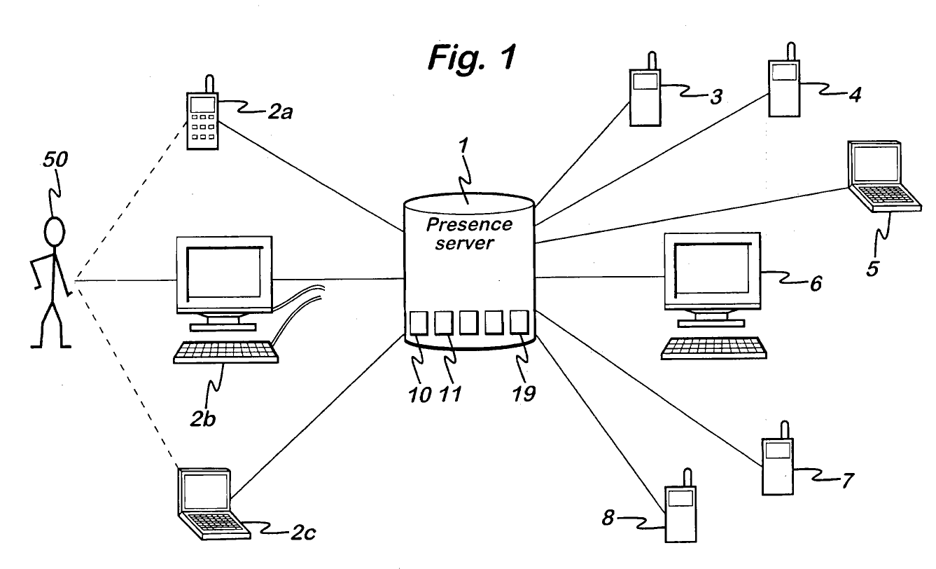

Referring first to FIG. 1, terminals 2a, 2b and 2c are associated with a user 50 who uses a presence service provided by a service provider. The presence service is an application managed by an application server of the mobile network, in this example a presence server 1. Terminal 2a is user 50's mobile phone, 2b is his PC and 2c is a PDA. User 50 could also add further terminals to the service if desired, or remove terminals.

In one embodiment of the present invention, a user's presence information is stored in the presence server 1 (and a copy of at least part of the information is also stored in the user's terminals). With reference to FIG. 1, each terminal 2a, 2b and 2c, and user 50, may all have presence information associated with them. This presence information and the presence information of other users and other terminals is stored in the presence server 1 as blocks of information 10-19.

If a watcher requests presence information about user 50 and all his terminals, then the presence server 1 creates a “presence document” containing the presence information of 2a, 2b, 2c and user 50. The presence document is then transmitted to the watcher. In various alternatives, depending on the watcher's request, the presence document may contain only the user 50's presence information, or the presence information of one or more terminals.

A particular presence document may thus be specific to a particular presentity's terminal or to a particular user in the present example. Alternatively, a presence document could contain information relating to multiple terminals or presentities and/or the information could be common to them all.

A presence document transmitted to a watcher may contain, for example: details of the different terminals used by user 50; the availability of the terminals for receiving communications; the preferred means of communication of each terminal at a given time; and general information related to the user which may be common to the different terminals. It is conceivable that almost any kind of information could be contained in presence documents if so desired.

User 50 can communicate with the server 1 via any of the three terminals 2a-c. HTTP or other protocols may be used for the communications.

FIG. 1 also shows terminals 3-8 of other presentities or watchers connected to the 3G network. Each of the terminals 3-8 can communicate, via SIP or HTTP or otherwise, with the server 1. Each presentity who subscribes to the presence service has an associated presence information block, such as one of blocks 10, 11, . . . 19.

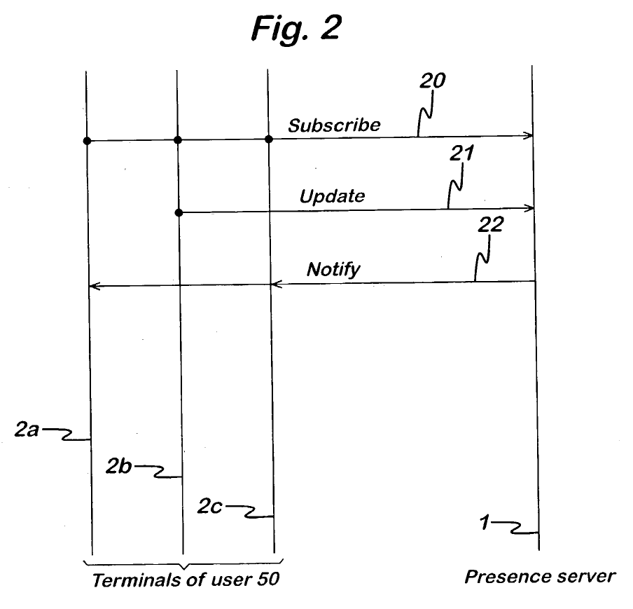

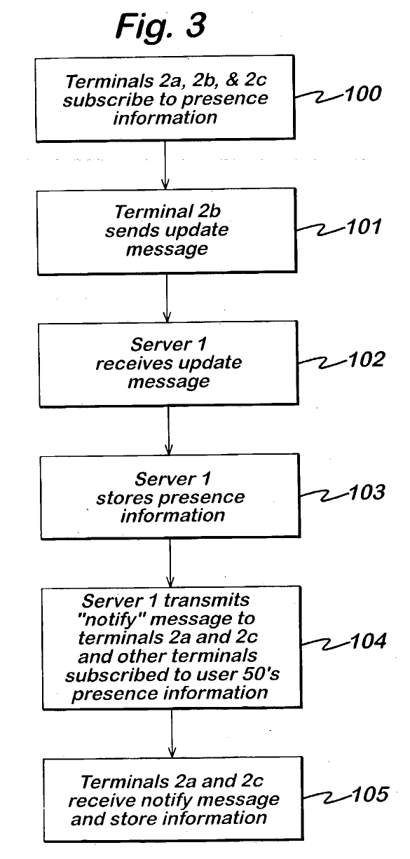

FIG. 2 represents the signals transmitted during an update of user 50's presence information in accordance with the exemplary embodiment of the present invention. FIG. 3 is a corresponding flow chart illustrating the sequence of events associated with a user updating his presence information also in accordance with the exemplary embodiment of the present invention. The particular embodiment of the present invention will now be described with reference to FIGS. 2 and 3.

In the example shown, user 50 uses one of his terminals such as his mobile phone 2a to transmit a SUBSCRIBE message to the presence server 1. The SUBSCRIBE message will typically be a SIP (session initiation protocol) message. This transmission is shown as 20 in FIG. 2, and as step 100 in FIG. 3. In the present example, terminals 2b and 2c are already subscribed to the presence information provided by server 1.

In general, in a presence service a SIP SUBSCRIBE message will be followed by a corresponding SIP NOTIFY message. For example, if a user subscribes to receive presence information of another user, he will subsequently receive a NOTIFY message to indicate the status of the event to which he subscribed, e.g. the presence information of the other user. The NOTIFY message will include presence information currently held in the presence server 1 that relates to the other user, and may consist of a presence document. An authorisation check will preferably be performed by the presence server 1 before the presence information is transmitted. In one embodiment, the server 1 has an access control list for each presentity, set up by the presentity himself, that specifies which other presentities and/or watchers are to be granted access to his presence information.

The subscriber will also receive NOTIFY messages each time the other user's presence information is changed. Such NOTIFY messages are not shown in the figures. Such NOTIFY messages are familiar to one skilled in the art.

It is also possible for a user to subscribe to specific presence information so that he will only receive a NOTIFY message when that particular information is updated.

In the exemplary embodiment, at some time after user 50 subscribes to presence server 1, he updates his presence information using his PC, 2b. User 50 sends a message 21 to the server 1. In accordance with the invention, the message 21 includes an identifier of the terminal used to make the update, i.e. an identifier for PC 2b. The message 21 may also include an identifier of the user 50. The user identifier may be in the form of an HTTP URL, and should preferably uniquely identify the presence information associated with user 50. The message 21 may also include information on the status of the user 50 or the terminal 2b, such as whether the user wishes to be able to receive communications via certain means. For example, the user may wish to prevent incoming calls to his mobile during a meeting. He could send a message to the server 1 indicating that he does not wish to be disturbed. The server 1 would then forward this information to any watchers subscribed to his presence information. The step of sending an update message is shown as 101 in FIG. 3.

The server 1 then receives message 21, identifies one or more appropriate presence information blocks 10-19, and stokes the updated presence information in the presence information blocks 10-19. The receiving and storing steps are labelled as 102 and 103 respectively in FIG. 3.

The server uses the terminal identifier to determine which of user 50's terminals transmitted the message 21, and consequently preferably transmits a NOTIFY message 22 (step 104 in FIG. 3) to terminals 2a and 2c which were not used to update the presence information. The contents of this NOTIFY message, defining the presence information of user 50 or one or more of his terminals, are then stored by the terminals 2a and 2c (step 105 in FIG. 3) so that each of user 50's three terminals has a local copy of that presence information which is relevant to the terminal, and the local copies remain synchronised with each other and with the presence information blocks 10-19 in the server 1. As mentioned above, preferably no NOTIFY message is transmitted to the terminal 2b that sent the update message 21.

In addition to transmitting the NOTIFY message 22 to terminals 2a and 2c, the server 1 may also transmit the message 22 to any other terminals 3-8 that are subscribed to user 50's presence information to alert the other subscribers to the change in user 50's presence information.

Preferably, it is possible for a user to update his or her presence information from a PC. It is preferred that the first message (the update message) should be capable of being transmitted from PCs. In the case where the first message is transmitted from a PC, additional authentication mechanisms may be used. This may be necessary for security reasons, since PCs generally do not have identities recognised by the 3G network. Similarly, all SUBSCRIBE messages from other terminals may require authentication mechanisms.

It is preferred that the update message can be sent to the presence server from any of the user's terminals, such as his mobile, his PC or his PDA.

The update message may suitably comprise details of the status of the user, such as whether or not he wishes to be contacted, and if so, by what means.

It will be apparent that the present invention is not limited to wireless networks, or terminals which communicate with a server via a wireless network.

The applicant draws attention to the fact that the present invention may include any feature or combination of features disclosed herein either implicitly or explicitly or any generalisation thereof, without limitation to the scope of any definitions set out above. In view of the foregoing description it will be evident to a person skilled in the art that various modifications may be made within the scope of the invention.

1. In a communication network including at least one user associated with a plurality of terminals, a method of administering presence information associated with at least one of the at least one user and the plurality of terminals, the method comprising: transmitting to a server a first message from a first one of said terminals, the first message comprising presence information and an identifier of the first terminal.

2. A method according to claim 1 further comprising the step of transmitting a second message including at least part of said presence information from the server.

3. A method according to claim 2 wherein the second message is transmitted to at least one of the other of said terminals.

4. A method according to claim 3 further comprising transmitting the second message to a plurality of the other of said terminals.

5. A method according to claim 3 further comprising transmitting the second message to all of the other of said terminals.

6. A method according to claim 1 further comprising transmitting the second message to terminals associated with other users.

7. A method according to claim 6 wherein the other users include watchers.

8. A method according to claim 1 wherein the first terminal of the user can be any one of the said plurality of terminals.

9. A method according to claim 1 wherein the first message comprises presence information related to at least one of the user and the first terminal.

10. A method according to claim 9 wherein the second message comprises presence information related to at least one of the user and the first terminal.

11. A method according to claim 1 wherein the first message comprises an identifier of the user.

12. A method according to claim 1 wherein the first terminal is a mobile telephone or a personal computer.

13. A method according to claim 1 wherein the first message is a SIP message or an HTTP message.

14. A method according to claim 1 wherein the second message is a SIP message or an HTTP message.

15. In a communication network including at least one user associated with a plurality of terminals, a server for administering presence information associated with at least one of the at least one user and the plurality of terminals, the server comprising: input means for receiving a first message from a first one of said terminals, the first message comprising presence information and an identifier of the first terminal.

16. A server according to claim 15, further comprising output means for transmitting a second message including at least part of said presence information.

17. A server according to claim 16 wherein the second message is transmitted to at least one of the other of said terminals of the user.

18. A server according to claim 17 wherein the second message is transmitted to a plurality of the other of said terminals.

19. A server according to claim 17 wherein the second message is transmitted to all of the other of said terminals.

20. A server according to claim 15 wherein the output means is adapted to transmit the second message to terminals associated with other users.

21 A server according to claim 20 wherein the other users include watchers.

22. A server according to claim 15 wherein the first terminal of the user can be any one of the said plurality of terminals.

23. A server according to claim 15 wherein the first message comprises presence information related to at least one of the user and the first terminal.

24. A server according to claim 23 wherein the second message comprises presence information related to at least one of the user and the first terminal.

25. A server according to claim 15 wherein the first message comprises an identifier of the user.

26. A server according to claim 15 wherein the first terminal is a mobile telephone or a personal computer.

27. A server according to claim 15 wherein the first message is a SIP message or an HTTP message.

28. A server according to claim 15 wherein the second message is a SIP message or an HTTP message.

29. A communication system including at least one user associated with a plurality of terminals, and a server for administering presence information associated with at least one of the at least one user and the plurality of terminals, wherein the server comprises input means for receiving a first message from a first one of said terminals, the first message comprising presence information and an identifier of the first terminal; and output means for transmitting a second message including at least part of said presence information.

30. A communication system according to claim 29 wherein the second message is transmitted to at least one of the other of said terminals.

31. A communication system according to claim 30 further comprising transmitting the second message to a plurality of the other of said terminals.

32. A communication system according to claim 30 further comprising transmitting the second message to all of the other of said terminals.

33. A communication system according to claim 30 wherein the output means is adapted to transmit the second message to terminals associated with other users.

34. A communication system according to claim 33 wherein the other users include watchers.

35. A communication system according to claim 30 wherein the first terminal of the user can be any one of the said plurality of terminals.

36. A communication system according to claim 30 wherein the first message comprises presence information related to at least one of the user and the first terminal.

37. A communication system according to claim 36 wherein the second message comprises presence information related to at least one of the user and the first terminal.

38. A communication system according to claim 30 wherein the first message comprises an identifier of the user.

39. A communication system according to claim 30 wherein the first terminal is a mobile telephone or a personal computer.

40. A communication system according to claim 30 wherein the first message is a SIP message or an HTTP message.

41. A communication system according to claim 30 wherein the second message is a SIP message or an HTTP message.
